(19) United States
(12) Patent Application Publication
(10) Pub. No.: US 2019/0171820 A1
(43) Pub. Date: Jun. 6, 2019

(54) Securing Resumption from Sleep Mode Using a Storage Medium Authentication Credential

(71) Applicant: Phoenix Technologies, Ltd., Campbell, CA (US)

(72) Inventor: Terry Chen, Taipei City (TW)

(21) Appl. No.: 15/830,778

(22) Filed: Dec. 4, 2017

(51) Int. Cl. G06F 21/57; G06F 9/44; G06F 21/44

(52) U.S. Cl. CPC G06F 21/575; G06F 9/4406; G06F 2011/2278; G06F 21/44; G06F 2221/034; G06F 9/4418

(57) ABSTRACT

Approaches for securing a persistent storage medium of a computer system. A computer system is instructed to transition from a sleep state to a working state. In response, a storage medium access module obtains, from a user of the computer system, an authentication credential required to access a persistent storage medium of the computer system. Upon successful validation of the authentication credential, the storage medium access module causes the computer system to transition from the sleep state to the working state. Upon being unable to successfully validate the authentication credential, the storage medium access module causing the computer system to remain in the sleep state.

### FIELD OF THE INVENTION

Embodiments of the invention relate to approaches for securing the digital data stored on a persistent storage medium.

### BACKGROUND

Theft of computerized devices is an ongoing concern is today's society. Beyond the obvious loss of the computerized device itself, thefts of this nature pose an additional hazard due to the sensitive nature of the data stored thereon. A person experiencing a loss of a computerized device may be exposed to theft of their digital data, such as their social security number, sensitive personal information, credit card and other payment information, and the like, which has the potential to be more impactful than the mere replacement cost of the computerized device itself.

One approach for securing a user's digital data involves the use of a password to lock, or secure access to, a hard-disk drive (HDD). To gain access to a locked hard-disk drive, a user must supply a correct password to a controller of the HDD. If the user is unable to unlock the HDD by supplying a correct password to the HDD controller within the allotted number of attempts, then the HDD remains inaccessible to the user.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a block diagram of system according to an embodiment of the invention;

FIG. 2 is a flowchart describing the high level steps of securing a persistent storage medium of a computer system according to embodiments of the invention; and

FIG. 3 is a block diagram that illustrates the hardware components of a computer system upon which an embodiment of the invention may be implemented.

### DETAILED DESCRIPTION OF THE INVENTION

Approaches for securing a persistent storage medium of a computer system, such as a hard-disk drive (HDD) or a solid-state device, are presented herein. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form or discussed at a high level in order to avoid unnecessarily obscuring teachings of embodiments of the invention.

### Functional Overview

It is recognized by the inventors that the password protection provided by certain locking mechanisms of digital storage devices may be circumvented in various circumstances, thereby rendering any digital data stored on the digital storage device vulnerable to compromise and theft. According to the current state of the art, a vulnerability exists in how persistent storage mediums, such as a HDD and a solid-state device, handle resumption from a sleep state to a working state when the persistent storage medium has been locked using an authentication credential. A persistent storage medium can reside in a locked state (i.e., the persistent storage medium requires an authentication credential to be successfully submitted by a user for that user to gain access to the persistent storage medium) or an unlocked state independent of whether the persistent storage medium is in a working state or a sleep state. However, currently there are no mechanisms for a user to submit a password or other authentication credential used to lock a persistent storage medium to the controller of that persistent storage medium to unlock the persistent storage medium when resuming from a sleep state.

When a user wakes a computer system from a sleep state (for example, by moving the mouse or submitting some input to the computer system via a user input device), the persistent storage medium enters a working state (i.e., it is no longer in a sleep state); however, the persistent storage medium of that computer system may still reside in a locked state. Because there exists no mechanism in the art for a user to supply the proper authentication credential to the controller of that persistent storage medium to unlock the persistent storage medium when the computer system in which it reside resumes from a sleep state, current approaches store the authentication credential required to unlock a persistent storage medium in a secret area of memory, potentially using a SMRAM. When the end user triggers a resume operation, either by the power button or other mechanism, the firmware assumes the end user should be given access to the persistent storage medium, and subsequently retrieves the authentication credential for the persistent storage medium from the secret location in memory and supplies that authentication credential to the controller of the persistent storage medium to cause the persistent storage medium to become unlocked in order to complete the resume process; then the operating system takes over control to authenticate the operation system password received from the end user.

A problem with this approach is that the security provided by an operating system password is much less than the security provided by locking a persistent storage medium using an authentication credential. The password used by an operating system may be obtained or circumvented via malicious means more easily than the authentication credentials used to lock a persistent storage medium. For example, assume that a computer system was stolen while the computer system resides in a sleep state and while the persistent storage medium of that stolen computer system was locked. In the current state of the art, the persistent storage medium of that stolen computer system will be automatically unlocked upon resuming to a working state (i.e., ACPI S0) from a sleep state if the malicious party is able to successfully log onto the operation system executing on the stolen computer system if the operating system is compromised. The malicious party might not know the operating system password in order to gain access of the persistent storage medium, however the malicious party may connect the persistent storage medium of the stolen computer system as a secondary storage device to a different computer system (the “hacking computer”) of the malicious party. Such a connection may be made using a “Y” cable for example. Then, if the malicious party instructs the hacking computer to resume from a sleep state to a working state, which the malicious party may easily do as they would be able to log onto the operation system running on the primary persistent storage device, then the BIOS or firmware on the stolen computer system will cause the authentication credential used to be secure the stolen persistent storage medium to be sent to the controller of the persistent storage device of the stolen computer to unlock the stolen persistent storage medium, thereby allowing the malicious party to gain access to its contents despite lacking the required authentication credentials to do so.

Advantageously, embodiments of the invention address and overcome these shortcomings of the existing art. In an embodiment, upon a storage medium access module detecting that a computer system has been instructed to transition from a sleep state to a working state, the storage medium access module obtains, from a user of the computer system, an authentication credential required to access the persistent storage medium. Upon successful validation of the authentication credential, the firmware causes the computer system to transition from a sleep state to a working state. However, upon being unable to successfully validate the authentication credential, the firmware causes the computer system to remain in the sleep state. In this way, even if a persistent storage medium, such as but not limited to a HDD, is stolen while the persistent storage medium is in a sleep state, a malicious party who lacks the authentication credential will not be able to unlock the persistent storage medium and gain access to any digital data stored thereon.

### System Overview

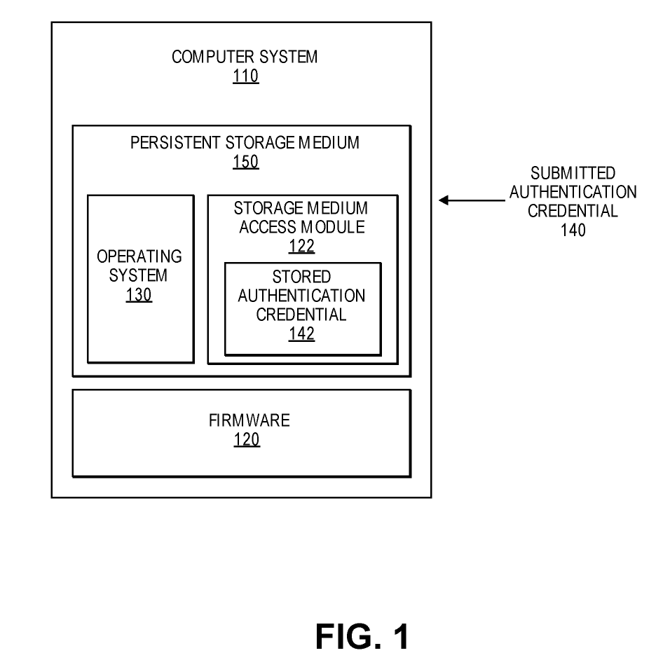

FIG. 1 is a block diagram of system according to an embodiment of the invention. FIG. 1 depicts computer system 110 upon which an embodiment of the invention may be implemented. FIG. 1 depicts certain logical components of computer system 110. Computer system 110 comprises firmware 120 and a persistent storage medium 150.

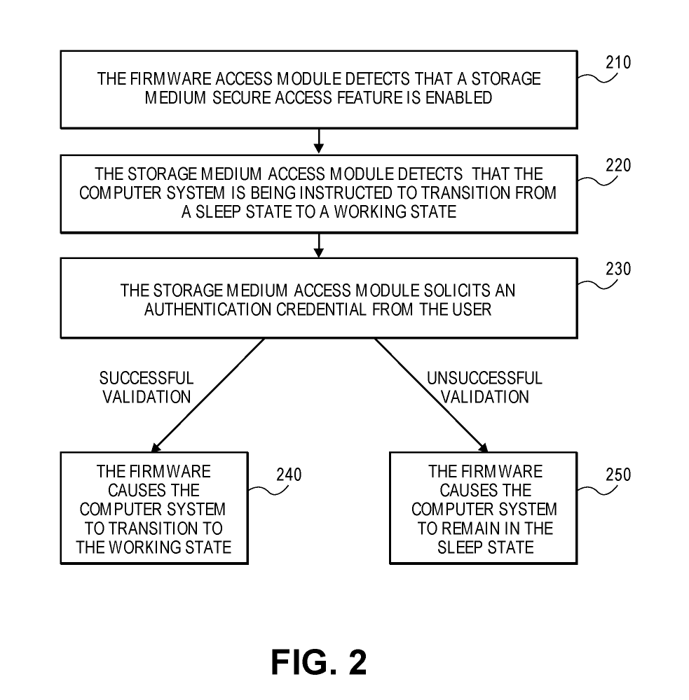

Firmware 120, as broadly used herein, corresponds to any type of firmware capable of performing the actions described below with reference to FIG. 2. In certain embodiments of the invention, firmware 120 may correspond to UEFI firmware, which as broadly used herein, corresponds to firmware that conforms to, or satisfies the requirements of, any version of any specification issued by the Unified Extensible Firmware Interface Forum (the “UEFI Forum”). The UEFI Forum is an alliance between several leading technology companies to modernize the booting process by use of the Unified Extensible Firmware Interface (UEFI) protocol.

Persistent storage medium 150, as broadly used herein, refers to any medium or mechanism usable by computer system 110 for persistently storing digital data. Non-limiting, illustrative examples of persistent storage medium 150 include magnetic storage (which includes for example a hard-disk drive (HDD)), optical disk drives (such as a CD-ROM for example), and solid state storage devices (such as memory cards, flash drives, and the like). While FIG. 1 depicts an embodiment in which computer system 110 employs a single persistent storage medium 150, embodiments of the invention may be employed with a computer system that employs two or more persistent storage mediums. In such an embodiment, the techniques discussed herein with respect to persistent storage medium 150 may be employed with and applied to each of the plurality of persistent storage medium 150 employed by the computer system. Stored on persistent storage medium 150 is at least one operating system 130 and a storage medium access module 122.

Operating system 130, as broadly used herein, refers to any type of operating system which may execute on computer system 110. While FIG. 1 depicts an embodiment in which computer system 110 executes a single operating system, embodiments of the invention may be employed with a computer system that executes two or more operating systems. In such an embodiment, the techniques discussed herein with respect to operating system 130 may be employed with and applied to each of the plurality of operating systems executing on the computer system.

Storage medium access module 122 represents software which performs certain responsibilities related to determining whether computer system 110 should resume to a working state from a sleep state. To do so, in an embodiment, storage medium access module 122 may obtain, from a user of computer system 110, a submitted authentication credential 140. Thereafter, the storage medium access module may validate the submitted authentication credential 140 to determine if it matches a stored authentication credential 142.

An authentication credential, such as submitted authentication credential 140 and stored authentication credential 142, as broadly used herein refers to any manner of digital information which can be used to validate a user's right to gain access to persistent storage medium 150. Non-limiting, illustrative examples of an authentication credential include a password, a token or certificate provided by an authentication server (not depicted in FIG. 1), and the like.

Having described certain logical components of computer system 110 according to an embodiment, approaches for securing persistent storage medium 150 of computer system 110 will now be discussed in further detail.

### Securing a Persistent Storage Medium

FIG. 2 is a flowchart describing the high level steps of securing a persistent storage medium of a computer system according to embodiments of the invention.

In step 210, firmware 120 detects that a storage medium secure access feature has been enabled. An example of a storage medium secure access feature of persistent storage medium 150 is a locking feature which prevents access to persistent storage medium 150 unless the user successfully submits authentication credential 140 within a predefined number of attempts. The security provided by embodiments may be implemented as a feature which may be enabled or disabled. For example, such a feature may only be enabled if at least one user has established a stored authentication credential 142. If this feature has not been enabled, then the remaining steps of FIG. 2 need not be performed.

In the performing step 210, when firmware 120 detects that the storage medium secure access feature is enabled and the persistent storage medium 150 is locked, firmware 120 will cause the state of operating system 130, including all contents of memory associated therewith, to be persistently stored on persistent storage medium 150 prior to computer system 110 being placed in a sleep state (ACPI S1-S3 states).

In step 220, storage medium access module 122 detects that computer system 110 has been instructed to resume from a sleep state. The state of an operating system is often identified using a set of states defined by an Advanced Configuration and Power Interface (ACPI) specification. The ACPI states are well-known to those in the art. Sleep states of computer system 110 commonly correspond to ACPI S1-S3 states, while a working state commonly corresponds to ACPI S0.

In step 230, storage medium access module 122 obtains a submitted authentication credential 140 from a user of computer system 110. The motivation for doing so is that storage medium access module 122 has detected computer system 110 is being instructed to resume from a sleep state, and so before making persistent storage medium 150 accessible to a user of computer system 110, the user's right to access persistent storage medium 150 is verified by validating a submitted authentication credential 140 submitted by the user.

In an embodiment, storage medium access module 122 obtains submitted authentication credential 140 by causing a user interface, capable of receiving user input, to be displayed to the user of computer system 110. Using the user interface, the user may provide submitted authentication credential 140 to storage medium access module 122. Embodiments of the invention may be configured such that storage medium access module 122 obtains submitted authentication credential 140 via means other than a user interface displayed to a user, e.g., storage medium access module 122 may obtain submitted authentication credential 140 via the user inserting a USB drive storing the authentication credential 140 into computer system 110 or by the user submitting authentication credential 140 via some other input device accessible to computer system 110.

Upon storage medium access module 122 successfully validating the authentication credential 140, step 250 is performed in which storage medium access module 122 causes firmware 120 to transition computer system 110 from the sleep state to a working state. The submitted authentication credential 140 may be validated by storage medium access module 122 using a variety of different means, e.g., storage medium access module 122 may compare submitted authentication credential 140 to stored authentication credential 142. Alternately, storage medium access module 122 may analyze the submitted authentication credential 140 using an algorithm or similar approach to ascertain whether the submitted authentication credential 140 is valid; thus, embodiments of the invention are not limited by use of a stored authentication credential 142 to validate submitted authentication credential 140.

In an embodiment, upon storage medium access module 122 successfully validating the authentication credential 140, a CPU reset is performed prior to performing Power On Self-Test (POST) operations. Also, storage medium access module 122 restores a state of memory for operating system 130 that was previously stored when performing step 210.

On the other hand, if storage medium access module 122 is unable to successfully validate authentication credential 140 in step 240, then step 250 is performed. In step 250, storage medium access module 122 causes firmware 120 to keep computer system 110 in a sleep state.

### Hardware Mechanisms

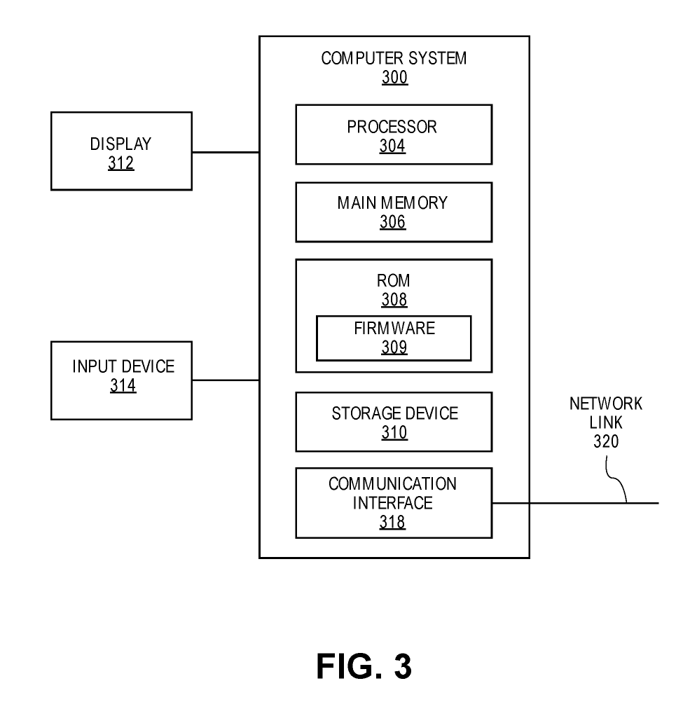

FIG. 3 is a block diagram that illustrates a computer system 300 upon which an embodiment of the invention may be implemented, such as computer system 400 of FIG. 4. In an embodiment, computer system 300 includes processor 304, main memory 306, ROM 308, storage device 310, and communication interface 318. Computer system 300 includes at least one processor 304 for processing information. Computer system 300 also includes a main memory 306, such as a random-access memory (RAM) or other dynamic storage device, for storing information and instructions to be executed by processor 304. Main memory 306 also may be used for storing temporary variables or other intermediate information during execution of instructions to be executed by processor 304.

Computer system 300 further includes a read only memory (ROM) 308 or other static storage device for storing static information and instructions for processor 304. ROM 308 may store UEFI firmware 309 in an embodiment. A storage device 310, such as a magnetic disk, optical disk, or flash drive, is provided for storing information and instructions.

Computer system 300 may be coupled to a display 312, such as a cathode ray tube (CRT), a LCD monitor, and a television set, for displaying information to a user. An input device 314, including alphanumeric and other keys, is coupled to computer system 300 for communicating information and command selections to processor 304. Other non-limiting, illustrative examples of input device 314 include a mouse, a trackball, or cursor direction keys for communicating direction information and command selections to processor 304 and for controlling cursor movement on display 312. While only one input device 314 is depicted in FIG. 3, embodiments of the invention may include any number of input devices 314 coupled to computer system 300.

Embodiments of the invention are related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement embodiments of the invention. Thus, embodiments of the invention are not limited to any specific combination of hardware circuitry and software.

The term “machine-readable storage medium” as used herein refers to any tangible medium that participates in storing instructions which may be provided to processor 304 for execution. Such a medium may take many forms, including but not limited to, non-volatile media and volatile media. Non-volatile media includes, for example, optical or magnetic disks, such as storage device 310. Volatile media includes dynamic memory, such as main memory 306.

Non-limiting, illustrative examples of machine-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read.

Various forms of machine readable media may be involved in carrying one or more sequences of one or more instructions to processor 304 for execution. For example, the instructions may initially be carried on a magnetic disk of a remote computer. The remote computer can load the instructions into its dynamic memory and send the instructions over a network link 320 to computer system 300.

Communication interface 318 provides a two-way data communication coupling to a network link 320 that is connected to a local network. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through a local network to a host computer or to data equipment operated by an Internet Service Provider (ISP).

Computer system 300 can send messages and receive data, including program code, through the network(s), network link 320 and communication interface 318. For example, a server might transmit a requested code for an application program through the Internet, a local ISP, a local network, subsequently to communication interface 318. The received code may be executed by processor 304 as it is received, and/or stored in storage device 310, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. One or more non-transitory machine-readable storage mediums storing one or more sequences of instructions for securing a persistent storage medium of a computer system, which when executed by one or more processors, cause:
upon detecting that the computer system has been instructed to transition from a sleep state to a working state, a storage medium access module obtaining, from a user of said computer system, an authentication credential required to access said persistent storage medium;
upon successful validation of the authentication credential, the storage medium access module causing the computer system to transition from the sleep state to the working state; and
upon being unable to successfully validate the authentication credential, the storage medium access module causing the computer system to remain in the sleep state.

2. The one or more non-transitory machine-readable storage mediums of claim 1, wherein the firmware causing the computer system to transition from the sleep state to the working state comprises:
performing a CPU reset prior to performing Power On Self-Test (POST) operations.

3. The one or more non-transitory machine-readable storage mediums of claim 1, wherein the firmware causing the computer system to transition from the sleep state to the working state comprises:
restoring a state of memory for an operating system that was previously stored prior to the operating system executing on the computer system entering the sleep state.

4. The one or more non-transitory machine-readable storage mediums of claim 1, wherein storage medium access module obtains the authentication credential by causing a user interface, capable of receiving user input, to be displayed to the user of the computer system.

5. The one or more non-transitory machine-readable storage mediums of claim 1, wherein the firmware is UEFI firmware that satisfies requirements of a version of any specification issued by the Unified Extensible Firmware Interface Forum.

6. The one or more non-transitory machine-readable storage mediums of claim 1, wherein said persistent storage medium is a solid-state device.

7. An apparatus for securing a persistent storage medium of a computer system, comprising:
one or more processors; and
one or more non-transitory computer-readable storage mediums storing one or more sequences of instructions, which when executed, cause:
upon detecting that the computer system has been instructed to transition from a sleep state to a working state, a storage medium access module obtaining, from a user of said computer system, an authentication credential required to access said persistent storage medium;
upon successful validation of the authentication credential, the storage medium access module causing the computer system to transition from the sleep state to the working state; and
upon being unable to successfully validate the authentication credential, the storage medium access module causing the computer system to remain in the sleep state.

8. The apparatus of claim 7, wherein the firmware causing the computer system to transition from the sleep state to the working state comprises:
performing a CPU reset prior to performing Power On Self-Test (POST) operations.

9. The apparatus of claim 7, wherein the firmware causing the computer system to transition from the sleep state to the working state comprises:
restoring a state of memory for an operating system that was previously stored prior to the operating system executing on the computer system entering the sleep state.

10. The apparatus of claim 7, wherein storage medium access module obtains the authentication credential by causing a user interface, capable of receiving user input, to be displayed to the user of the computer system.

11. The apparatus of claim 7, wherein the firmware is UEFI firmware that satisfies requirements of a version of any specification issued by the Unified Extensible Firmware Interface Forum.

12. The apparatus of claim 7, wherein said persistent storage medium is a solid-state device.

13. A method for securing a persistent storage medium of a computer system, comprising:
upon detecting that the computer system has been instructed to transition from a sleep state to a working state, a storage medium access module obtaining, from a user of said computer system, an authentication credential required to access said persistent storage medium;
upon successful validation of the authentication credential, the storage medium access module causing the computer system to transition from the sleep state to the working state; and
upon being unable to successfully validate the authentication credential, the storage medium access module causing the computer system to remain in the sleep state.

14. The method of claim 13, wherein the firmware causing the computer system to transition from the sleep state to the working state comprises:
performing a CPU reset prior to performing Power On Self-Test (POST) operations.

15. The method of claim 13, wherein the firmware causing the computer system to transition from the sleep state to the working state comprises:
restoring a state of memory for an operating system that was previously stored prior to the operating system executing on the computer system entering the sleep state.

16. The method of claim 13, wherein storage medium access module obtains the authentication credential by causing a user interface, capable of receiving user input, to be displayed to the user of the computer system.

17. The method of claim 13, wherein the firmware is UEFI firmware that satisfies requirements of a version of any specification issued by the Unified Extensible Firmware Interface Forum.

18. The method of claim 13, wherein said persistent storage medium is a solid-state device.
